(19) United States
(12) Patent Application Publication
(10) Pub. No.: US 2024/0296620 A1
(43) Pub. Date: Sep. 5, 2024

(54) SYSTEM AND METHOD FOR MEASURING SURFACE FEATURES ON SKIN

(71) Applicant: The Gillette Company LLC, Boston, MA (US)

(72) Inventors: Balasundram Periasamy Amavasai, Reading (GB); Kevin David Cowley, Reading (GB); Philip Bellamy, Reading (GB)

(21) Appl. No.: 18/594,659

(22) Filed: Mar. 4, 2024

Related U.S. Application Data
(60) Provisional application No. 63/449,495, filed on Mar. 2, 2023.

(51) Int. Cl. G06T 17/00; G06T 7/00; G06T 7/60; G06T 7/80; H04N 23/90

(52) U.S. Cl. CPC G06T 17/00; G06T 7/0002; G06T 7/60; G06T 7/80; H04N 23/90; G06T 2207/30088

(57) ABSTRACT

A system and method are provided for gathering image data of a surface feature. The system includes cameras and optical elements configured to receive light from an area of a surface having one or more features and to direct the light to the cameras. The system also includes a processor communicatively coupled with the cameras. A memory of the processor includes a sequence of instructions to cause the system to determine 3D calibration data of the cameras; automatically receive image data of the area in focus from the cameras over a plurality of frames; and automatically determine a 3D bitmap image for each frame based on the image data for each frame. The 3D calibration data and 3D bitmap images are stored in the processor memory. A method uses the 3D calibration data and 3D bitmap images to measure one or more parameters of the surface feature.

The present disclosure relates generally to 3D modelling of surface features and more specifically to 3D modelling of skin surface features.

### BACKGROUND

Measurement of the closeness of a shave is a critical aspect of shaving performance. Traditional methods have used an optical stereo microscope (Leica-Reflex) attached with a glass plate for subjects to lay their face on. This enables an operator looking down the stereo viewfinder to gain a 3D view of the skin surface to identify, then manually measure, the length of any visible hairs using the calibrated microscope tools.

More recent systems 10 (see FIG. 1A) use a high-resolution camera to take pictures of facial hairs 16 at a fixed distance. This system 10 uses a glass plate 12 pushed against the skin surface 14 to flatten hairs 16 against the skin surface 14. This system 10 then captures a 2D image of the flattened hair 16 in order to estimate the hair length.

The discussion of shortcomings and needs existing in the field prior to the present disclosure is in no way an admission that such shortcomings and needs were recognized by those skilled in the art prior to the present disclosure.

### SUMMARY

Various embodiments solve the above-mentioned problems and provide methods and devices useful for generating a 3D model of surface features to measure one or more parameter values of the surface features.

Various drawbacks were recognized of the conventional systems and methods used to measure hair parameters. As shown in FIG. 1A, the skin surface 14 is deformed with the glass plate 12 by a distance 18. This deformation can introduce errors in the length measurement of the hair 16. For example, this skin deformation may cause the hair 16 to extend from the skin surface 14 by a greater length than without the deformation. Additionally, the deformation of the skin surface 14 may cause hairs 16 that were otherwise within the skin surface 14 to pop out, resulting in a length measurement of hairs 16 that were previously unexposed. Furthermore, as shown in FIG. 1A, the deformation of the skin surface 14 may cause short hairs 16 to be pushed by the distance 20 back into the skin surface 14, resulting in hairs appearing to be shorter than if not pressed against the glass plate 12. To overcome these drawbacks, the system of the present disclosure was developed to be contactless and thus not make contact with the skin surface 14 when measuring one or more hair parameters.

Additionally, it was recognized that the conventional systems and methods used to measure hair parameters are limited in terms of which parameters of the hair can be measured. For example, only the length and diameter of the hair is typically measured with these conventional systems and methods. Since these conventional systems compress the hair 16 along the skin surface 14 with the glass plate 12, other parameters such as one or more angles of the hairs 16 relative to the skin surface 14 cannot be measured. These drawbacks of the conventional systems were also overcome by the improved contactless system disclosed herein which does not make contact with the skin surface 14. By not making contact with the skin surface 14, the improved system and method can measure numerous parameters of hairs which cannot be measured with the conventional systems.

Additionally, it was recognized that some of the conventional systems (Leica-Reflex) require manual measurement of the hair length and thus limit measurements to a very small region of the face, usually just the cheek, and limit the number of hairs which can be measured to about 50. To overcome this drawback of conventional systems, the improved method of the present disclosure was developed which advantageously measures multiple different types of parameters of a large number of hairs (e.g. thousands) in a very short period of time (e.g. seconds).

In a first embodiment of the present disclosure, a system is provided that includes a plurality of cameras and a plurality of optical elements configured to receive light from an area of a surface having one or more features and to direct the light to the plurality of cameras. The system also includes a processor communicatively coupled with the plurality of cameras. A memory of the processor includes a sequence of instructions. The memory and the sequence of instructions are configured to, with the processor, cause the system to determine 3D calibration data of the plurality of cameras. The memory and the sequence of instructions are further configured to, with the processor, cause the system to automatically receive image data of the area in focus from the plurality of cameras over a plurality of frames and automatically determine a 3D bitmap image for each of the plurality of frames based on the image data for each of the plurality of frames. The memory and the sequence of instructions are further configured to, with the processor, cause the system to store in the memory the 3D calibration data and the 3D bitmap images over the plurality of frames.

In a second embodiment of the present disclosure, a method is provided that includes determining, with a processor, 3D calibration data of a camera system including a plurality of cameras. The method further includes automatically receiving, at the processor, first image data of an area of a surface having one or more features from the camera system over a plurality of frames. The method further includes automatically determining, with the processor, a 3D bitmap image for each of the plurality of frames based on the first image data for each of the plurality of frames. The method further includes storing, with the processor, the 3D calibration data and the 3D bitmap images over the plurality of frames.

In a third embodiment of the present disclosure, a method is provided that includes receiving, at a processor, 3D calibration data and a plurality of 3D bitmap images of a surface having one or more features over a respective plurality of frames. The method further includes automatically determining, with the processor, whether a surface feature in the 3D bitmap image for each frame is in focus. The method further includes automatically determining, with the processor, a 3D model of the surface features based on the 3D calibration data and one or more of the 3D bitmap images where the surface feature is in focus. The method further includes automatically determining, with the processor, a value of one or more parameters of the surface feature that is in focus based on the 3D model for the plurality of frames. The method further includes automatically calculating, with the processor, a characteristic value of the one or more parameters of the surface feature over the plurality of frames. The method further includes storing, with the processor, the calculated characteristic value of the one or more parameters of the surface feature and an identifier that indicates the surface feature.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures.

FIG. 1A is an example illustrating a side view of a conventional system used to measure hair length;

FIG. 1B is an example according to various embodiments illustrating a side view of a system to gather image data of a surface feature;

FIG. 2A is an example according to various embodiments illustrating a block diagram of a system to gather image data of a surface feature;

FIG. 2B is an example according to various embodiments illustrating a block diagram of the system of FIG. 2A taken along the line 2B-2B;

FIG. 2C is an example according to various embodiments illustrating a block diagram of a system to gather image data of a surface feature;

FIG. 3A is an example according to various embodiments illustrating a top perspective exploded view of a system to gather image data of a hair on a skin surface;

FIG. 3B is an example according to various embodiments illustrating the cameras, lenses and skin surface in the system of FIG. 3A;

FIG. 4A is an example according to various embodiments illustrating an out of focus region in an image captured from the cameras of the system of FIG. 2A;

FIG. 4B is an example according to various embodiments illustrating an in-focus region in an image captured from the cameras of the system of FIG. 2A;

FIG. 5A is an example according to various embodiments illustrating a 3D bitmap image of skin features based on the image data collected by the system of FIG. 2A;

FIG. 5B is an example according to various embodiments illustrating a 3D bitmap image of skin features based on the image data collected by the system of FIG. 2A;

FIG. 5C is an example according to various embodiments illustrating a front view of a calibration object used to calibrate the system of FIG. 2A;

FIG. 5D is an example according to various embodiments illustrating a 3D bitmap image of the calibration object of FIG. 5C based on the image data collected from the system of FIG. 2A;

FIGS. 6A through 6C are examples according to various embodiments illustrating image data of the skin features collected by the cameras of the system of FIG. 2A;

FIG. 6D is an example according to various embodiments illustrating a graph of a measured parameter value of a hair on the skin surface over a plurality of frames;

FIG. 6E is an example according to various embodiments illustrating image data of hairs on a skin surface with one or more location identifiers and tracking splices for the hairs;

FIG. 6F is an example according to various embodiments illustrating image data of hairs on a skin surface with a trace indicating an error measurement of a hair;

FIGS. 7A through 7D are examples according to various embodiments illustrating different parameters of hairs on the skin surface;

FIG. 8A is an example according to various embodiments illustrating a flow diagram of a method to capture image data of surface features with the system of FIG. 2A;

FIG. 8B is an example according to various embodiments illustrating a flow diagram of a method to measure a value of one or more parameters of surface features based on the image data captured with the system of FIG. 2A;

FIG. 9 is an example according to various embodiments illustrating a block diagram of a computer system upon which an embodiment of the disclosure may be implemented; and

FIG. 10 is an example according to various embodiments illustrating a chip set upon which an embodiment of the disclosure may be implemented.

It should be understood that the various embodiments are not limited to the examples illustrated in the figures.

### DETAILED DESCRIPTION

### Introduction and Definitions

This disclosure is written to a person having ordinary skill in the art, who will understand that this disclosure is not limited to the specific examples or embodiments described. The examples and embodiments are single instances of the disclosure which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Some embodiments of the disclosure are described below in the context of using a system to capture image data of surface features (e.g. hairs) on a surface (e.g. skin surface) and a method to measure a value of one or more parameters of the hairs on the skin surface based on this captured image data. However, the disclosure is not limited to this context. In other embodiments, the system can be used to capture image data of any other features (e.g. moles, skin flakes, clothing fibers) on the skin surface other than hairs and a method to measure a value of one or more parameters of these other features based on the captured image data. In some embodiments, the method disclosed herein tracks the position and/or orientation of multiple features (e.g. hair, mole, skin flakes, clothing fiber) on the skin surface in order to use the relative position and/or orientation between different features to determine the position and/or orientation of one of the features (e.g. hairs). However, in other embodiments, the system is not limited to skin features and can be used to capture image data of any surface feature on any surfaces and a method that can be used to measure a value of one or more parameters of the surface features.

### System Overview

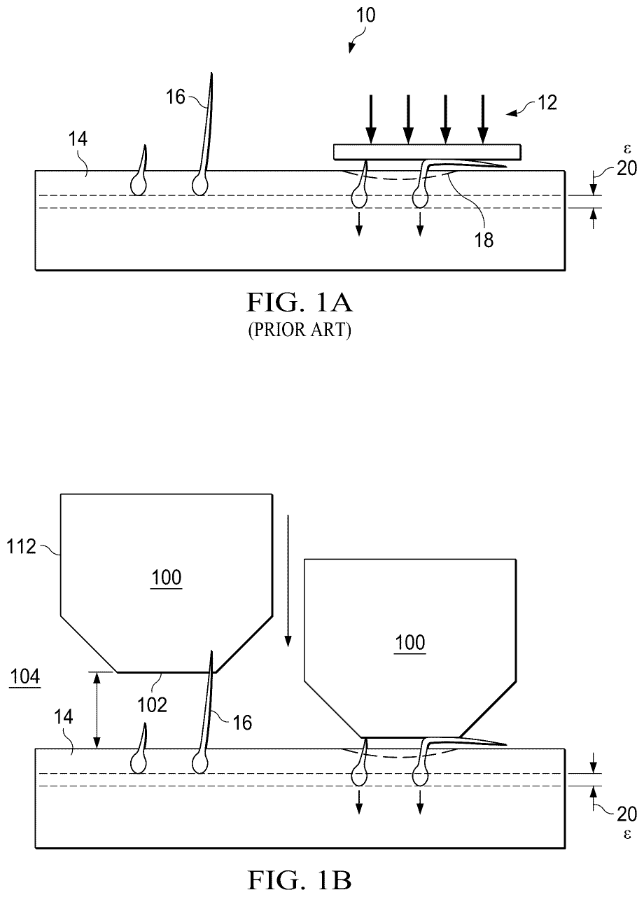

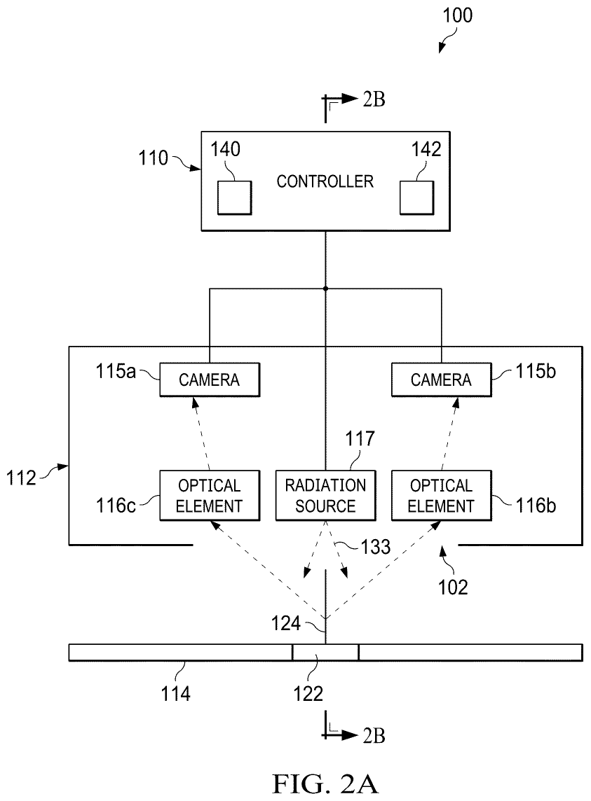

A system that is used to gather image data of surface features of a surface will now be discussed. In one embodiment, the system is used to gather image data of skin features (e.g. hair) on a skin surface. FIG. 1B is an example according to various embodiments illustrating a side view of a system 100 to gather image data of a surface feature. In an embodiment, the system 100 includes a housing 112 that defines an opening 102. As shown in FIG. 1B the system 100 is a contactless system that does not make contact with the skin surface 14. The housing 112 of the system 100 is positioned within a distance 104 from the skin surface 14. In one embodiment, the distance 104 is based on a focal length of one or more optical elements of the system 100 so that captured image data of the skin features (e.g. hairs 16) on the skin surface 14 are in focus. In an example embodiment, the distance 104 is between about 400 μm and about 800 μm. As shown in FIG. 1B, when the housing 112 of the system 100 is moved too close to the skin surface 14, the system 100 stops capturing image data since such image data is out of focus with the skin features (e.g. hairs 16) on the skin surface 14. As shown in FIG. 1B, the opening 102 of the housing 112 is provided such that skin features (e.g. hair 16) which may extend beyond the distance 104 are not contacted by the housing 112, since they extend through the opening 102. It was recognized that this advantageously ensures that the position and orientation of the hairs 16 is not affected by the housing 112 and thus an accurate measurement of hair parameters (e.g. length, angle relative to the skin surface 14, etc.) can be obtained. Hence, this design of the system 100 overcomes the previously discussed drawbacks of the conventional systems due to contacting the hairs on the skin surface.

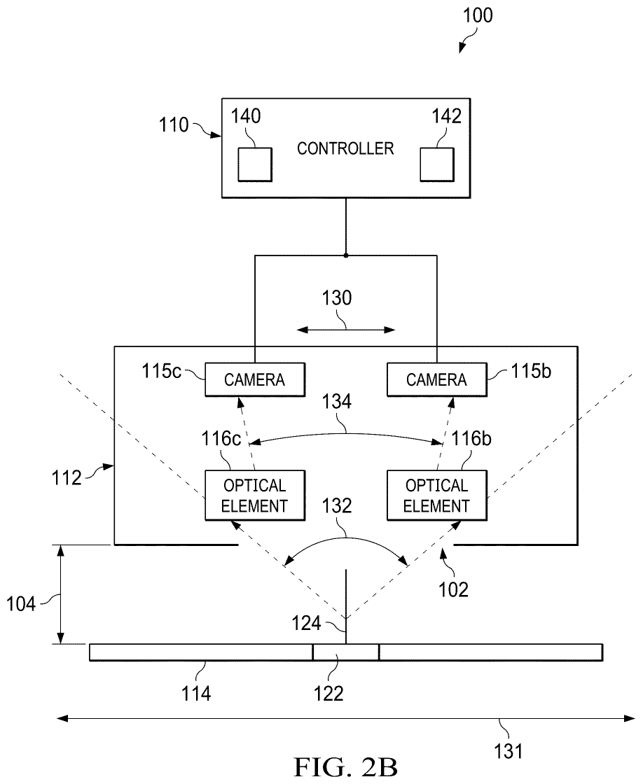

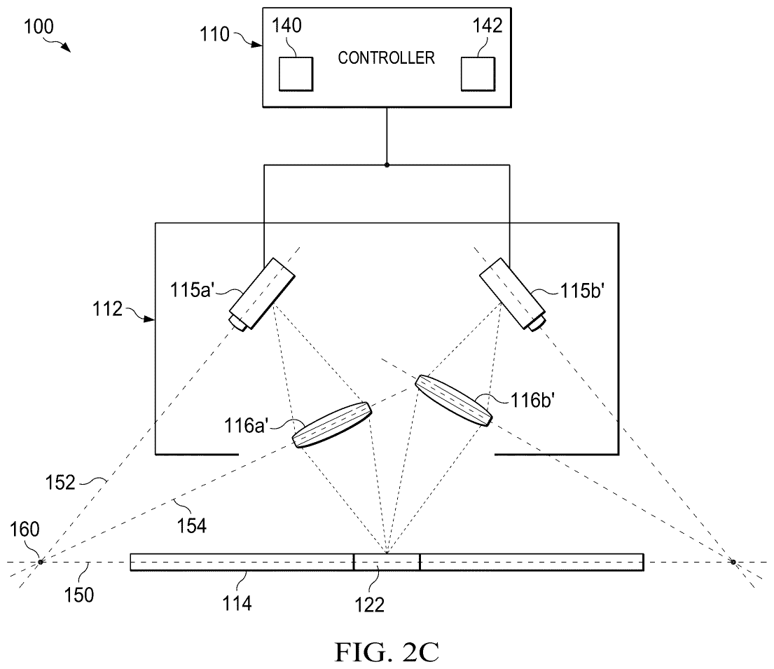

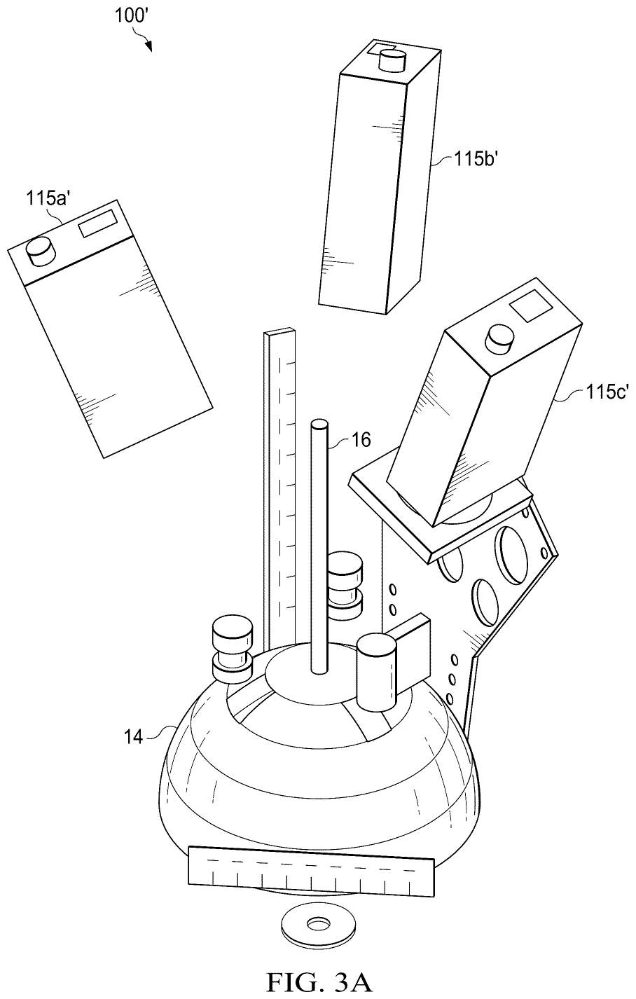

FIG. 2A is an example according to various embodiments illustrating a block diagram of a system 100 to gather image data of a surface feature 124. FIG. 2B is an example according to various embodiments illustrating a block diagram of the system 100 of FIG. 2A taken along the line 2B-2B. In some embodiments, the surface 114 is a skin surface and the surface feature 124 is a skin feature (e.g. hair 16, mole, skin flake, etc.). However, the system 100 is not limited to gathering image data of skin features on the skin surface and can also gather image data of non-skin features (e.g. clothing fibers) on the skin surface. Additionally, the system 100 is not limited to capturing image data of features on a skin surface and can be used to capture image data of any surface feature on any surface.

In an embodiment, as shown in FIG. 2A the system 100 includes a radiation source 117 that is configured to emit a radiation signal 133 to illuminate surface features 124 in an area 122 of the surface 114. In an embodiment, the radiation source 117 is selected such that the illuminated surface feature 124 will stand out relative to the surface 114. In this embodiment, the radiation source 117 is selected to provide a strong contrast between reflected light from the surface feature 124 and reflected light from the surface 114 that is detected by the cameras 115a-115c of the system 100. It was recognized that it would be advantageous to select the radiation source 117 such that the contrast between reflected light from the surface feature 124 (e.g. hair 16) is relatively large compared to reflected light from the surface 114 (e.g. skin surface 14). In an example embodiment, the wavelength of the radiation source 117 is selected within a particular range, since it was recognized that use of specific wavelengths of light (e.g., visible and non-visible) make some features stand out better than others. In one example embodiment, the radiation source 117 is selected to emit green light (e.g., in a wavelength range between about 500 nm and about 560 nm) as this is a known wavelength range to provide a strong contrast between most skin types and hair. In another example embodiment, the radiation source 117 is selected to emit blue/purple light (e.g., in a wavelength range between about 380 nm and about 480 nm), as this light is often used for providing contrast between dry skin and well moisturized skin. However, it was recognized that the wavelength of the radiation source 117 should be selected based on the particular surface feature (e.g. hair 16) being imaged and measured.

In some embodiments, the radiation source 117 is modular and thus can be easily removed and/or replaced from the system 100 (e.g. from within the housing 112). Although FIG. 2A depicts the radiation source 117 within the housing 112, in other embodiments the radiation source 117 is external to the housing 112 (e.g. mounted to an external surface of the housing 112 or in a separate housing from the housing 112, etc.) It was recognized that providing a modular radiation source 117 advantageously permits the radiation source to be easily changed, thereby being able to switch operational parameters (e.g. lighting wavelength, intensity, pulsing features, etc.) of the radiation source 117 depending on the particular surface feature that is to be imaged and measured. In other embodiments, the radiation source 117 can be a variable wavelength source (e.g., variable wavelength LED), so that such operational parameters (e.g. wavelength) of the radiation source 117 can be changed even within a measurement, enabling different types of surface features to be identified within a single measurement.

In some embodiments, the radiation source 117 is a short-wave infra-red (SWIR) light source and the cameras 115a-115c are configured to detect SWIR light. It was recognized that at these wavelengths, water absorbs the infrared (IR) light strongly. Since skin is water-rich and hair is not, reflected light intensity from the skin is low (e.g. pixel intensity will be low in images captured with the cameras 115 a-115c) whereas reflected light intensity from hairs is high (e.g. pixel intensity will be high in images captured with the cameras 115a-115c). This provides excellent contrast for imaging and measuring parameter values of hairs on the skin surface. In an example embodiment, the radiation source 117 has a SWIR wavelength in a range between about 1400 nm and 1550 nm.

In an embodiment, the system 100 includes a plurality of cameras 115a through 115c. Although three cameras 115a through 115c are depicted in FIGS. 2A and 2B, in other embodiments of the system less or more than three cameras may be used. The cameras 115a-115c are positioned and oriented to capture image data of surface features 124 from the area 122 of the surface 114 at different angles. This captured image data of the surface features 124 at the area 122 of the surface 114 at different angles is advantageously used by the method disclosed herein to obtain 3D bitmap images and 3D models of the surface features 124. In an embodiment, the cameras 115a-115c capture reflected light from the surface features 124 illuminated with the transmitted light 133 from the radiation source 117. Thus, in an embodiment, the cameras 115a-115c are configured to detect reflected light having a wavelength that is similar to the wavelength of the radiation source 117.

The system 100 also includes a plurality of optical elements 116a-116c configured to receive reflected light from the surface features 124 in the area 122 of the surface 114. Although three optical elements 116a-116c are depicted in FIGS. 2A and 2B, in other embodiments of the system less or more than three optical elements may be used (e.g. the same number as the number of cameras 115a-115c). The plurality of optical elements 116a-116c are further configured to direct the light to the plurality of cameras 115a-115c. In one embodiment, as shown in FIG. 2B, the plurality of optical elements 116a-116c are configured to reduce a first angular spread 132 of light received from the surface features 124 in the area 122 of the surface 114 to a second angular spread 134 of light incident on the plurality of cameras 115a-115c. In this embodiment, the second angular spread 134 is less than the first angular spread 132. It was recognized that the reduction of the angular spread advantageously permits the housing 112 holding the cameras 115a-115c to be much smaller than without the optical elements 116a-116c. This design feature is depicted in FIG. 2B, where the plurality of cameras 115a-115c are spaced apart by a first distance 130 that is less than a second distance 131 which the plurality of cameras 115a-115c would need to be spaced to receive light having the first angular spread 132 without the optical elements 116a-116c.

The housing of the system 100 will now be discussed. As shown in FIGS. 2A and 2B, in an embodiment the system 100 includes the housing 112 defining the opening 102 that was previously discussed with respect to FIG. 1B. In one embodiment, the plurality of cameras 115a-115c are positioned within the housing 112. The plurality of optical elements 116a-116c are also positioned within the housing 112 between the opening 102 and the plurality of cameras 115a-115c. In this embodiment, the plurality of optical elements 116a-116c are configured to receive light through the opening 102 from the surface features 124 in the area 122. As shown in FIG. 2B, in an embodiment the housing 112 is configured to be positioned within the distance 104 (e.g. between about 400 μm and about 800 μm) from the area 122 of the surface 114. As further shown in FIGS. 2A and 2B, the opening 102 of the housing 112 is dimensioned in a direction normal to the surface 114 such that the opening 102 is configured to receive a tip of a surface feature 124 (e.g. hair 16) extending from the area 122 of the surface 114. Additionally, in these embodiments, the plurality of optical elements 116a-116c are arranged within the housing 112 so to not make contact with the tip of the surface feature 124 extending through the opening 102 into the housing 112.

A controller of the system will now be discussed which is communicatively coupled with one or more components of the system 100. As shown in FIGS. 2A and 2B, in one embodiment the system 100 includes a controller 110 communicatively coupled with the radiation source 117 and the plurality of cameras 115a-115c. In an embodiment, the controller 110 is configured to transmit a signal to the plurality of cameras 115a-115c to cause the cameras to capture image data of the surface 114 over a plurality of frames. In this embodiment, the controller 110 is also configured to transmit a signal to the radiation source 117 to cause the radiation source 117 to emit the transmitted light 133 over the plurality of frames so that the transmitted light 133 is emitted at each frame of the plurality of frames. In an example embodiment, the controller 110 transmits simultaneous signals to both the radiation source 117 and the cameras 115a-115c so that the light 133 is transmitted by the radiation source 117 and the reflected light from the surface features 124 is captured by the cameras 115a-115c at each frame of the plurality of frames. As appreciated by one of ordinary skill in the art, cameras routinely capture a certain number of frames per second (e.g. 30 frames per second, 100 frames per second, etc.). In these embodiments, based on this known frame capture rate, the controller 110 transmits a signal to the cameras 115a-115c to cause the cameras to capture image data over a certain time period (e.g. 5 seconds, 1.5 seconds, etc.) in order to obtain a desired number of frames (e.g. 150). However, these example values of the frame capture rate, time period and desired number of frames are just one example of such values and embodiments of the present disclosure include any such values for these parameters. In an embodiment, the controller 110 is also configured to receive signals from the cameras 115a-115c that convey image data of each of the plurality of frames captured of the area 122 of the surface 114.

In an embodiment, more than one radiation source 117 is included in the system 100. In an example embodiment, the system 100 includes a plurality (e.g. three) LEDs for the radiation sources, which pulse simultaneously, in step with the frame capture rate of the cameras 115a-115c. In other embodiments, more than three LEDs can be used for the radiation sources 117, such as seven LEDS. In still other embodiments, each of the plurality of radiation sources (e.g. each of the seven LEDs) are individually controlled. In still other embodiments, the plurality of radiation sources can be arranged in a particular arrangement (e.g. in a ring, with one LED at the center). In an example embodiment, the plurality of LEDS (e.g. seven LEDS) can be arranged in a ring with a single LED at the center. In still other embodiments, each of the plurality of radiation sources can be pulsed in various patterns (e.g. can be pulsed in a sequential manner, such as the multiple LEDS arranged in a ring). It was recognized that pulsing the multiple LEDs in a sequential manner may provide various advantages, such as better 3D shape identification of the surface features. In an example embodiment, where the multiple LEDs are arranged in a ring and pulsed in a sequential manner, the multiple LEDs can be pulsed based on a certain time period for the circularly arranged LEDs (e.g. 100 milliseconds, where the pulse goes around the ring of LEDs 10 times each second).

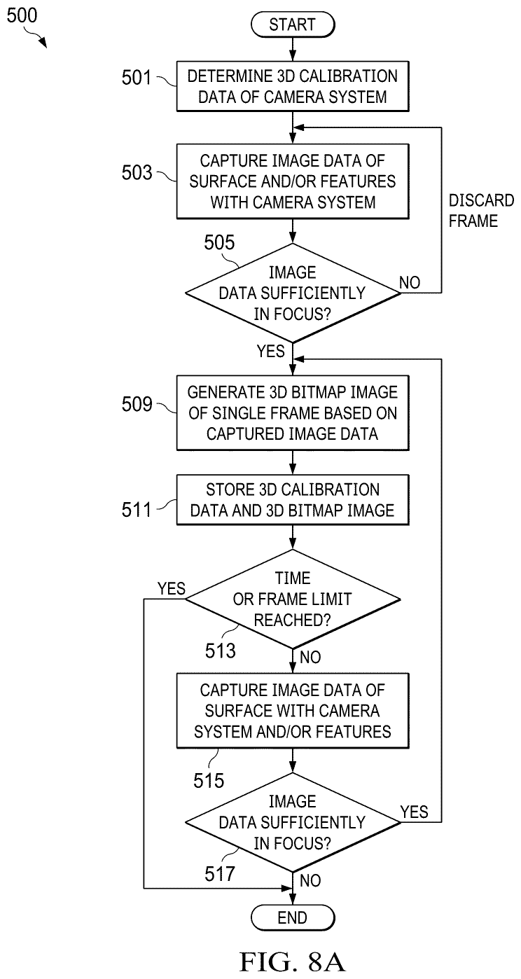

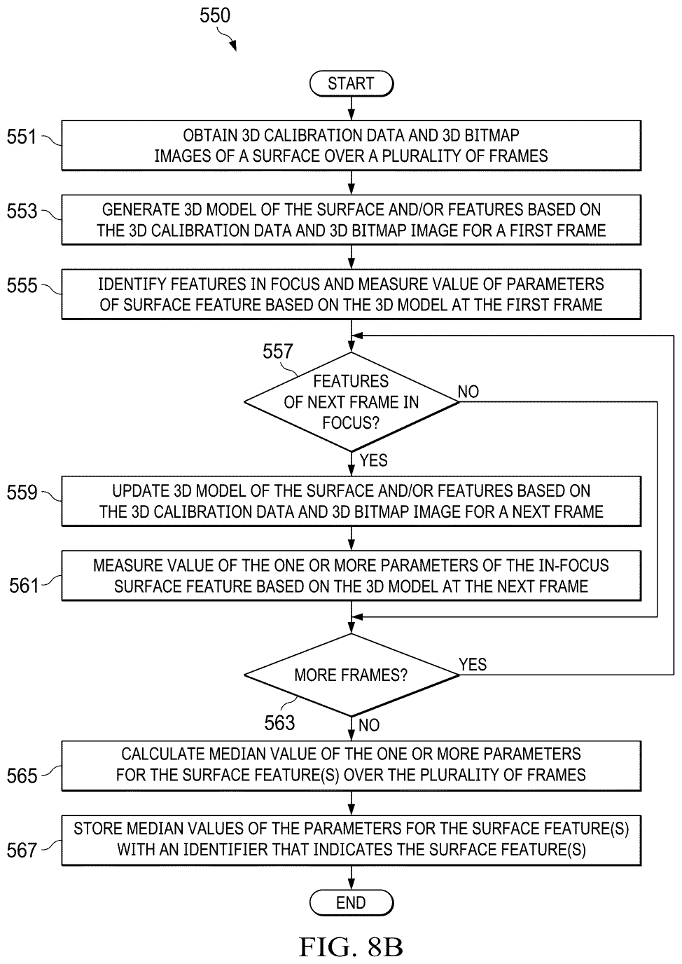

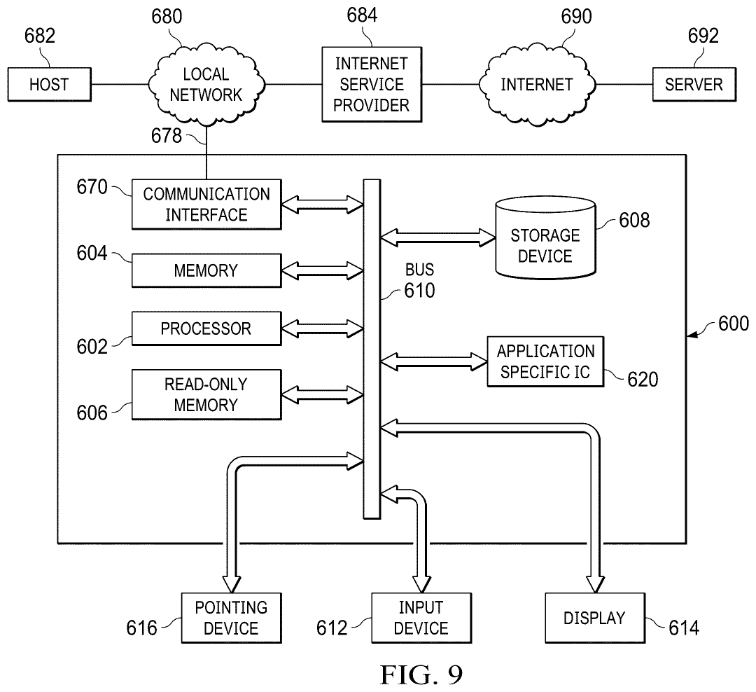

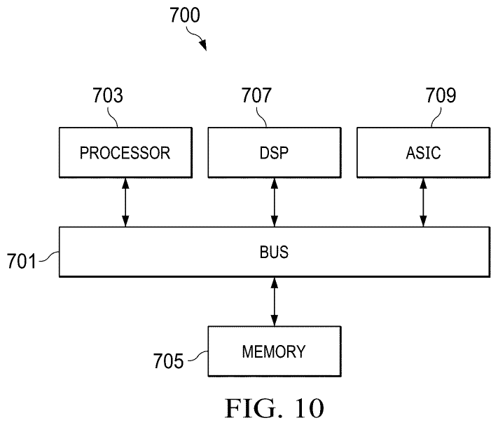

In various embodiments, the controller 110 includes an image data gathering module 140 that includes instructions to cause the controller 110 to perform one or more steps of the method 500 of FIG. 8A. In other embodiments, the controller 110 includes an image data processing module 142 that includes instructions to cause the controller 110 to perform one or more steps of the method 550 of FIG. 8B. In some embodiments, the controller 110 is a general purpose computer system, as depicted in FIG. 9 or one or more chip sets as depicted in FIG. 10.

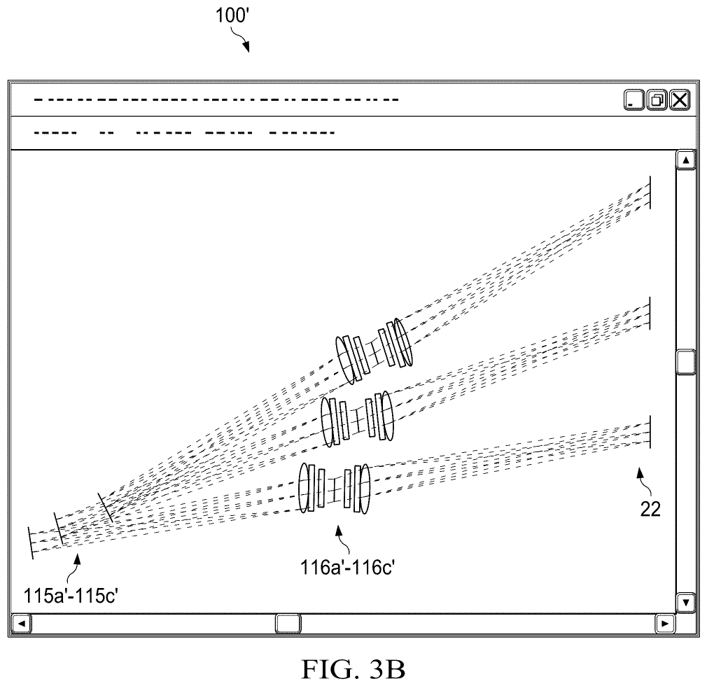

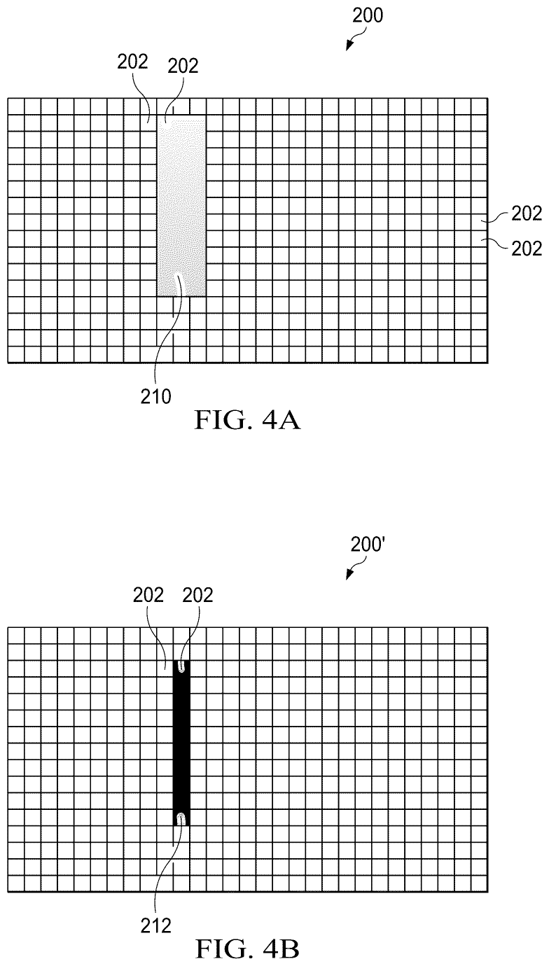

One embodiment of the system is now discussed, where the arrangement of the components advantageously results in a compact housing holding the components. FIG. 2C is an example according to various embodiments illustrating a block diagram of a system 100′ to gather image data of a surface feature. FIGS. 3A and 3B are examples according to various embodiments that illustrate a top perspective exploded view of the system 100′ of FIG. 2C that is used to gather image data of the hair 16 on the skin surface 14, according to an embodiment. The system 100′ is similar to the system 100 previously discussed, with the exception of the features discussed herein.

As shown in FIG. 2C, in an embodiment the plurality of cameras 115a-115c define a respective plurality of image planes 152 and the plurality of optical elements 116a-116c define a respective plurality of optical planes 154. The plurality of optical elements 116a-116c are configured such that each optical plane 154 intersects at least one of the image planes 152 within a plane of focus 150. In these embodiments, the plane of focus 150 corresponds to the plane in which the optical elements 116a-116c are focused (e.g. the plane corresponding to the surface features 124). In an example embodiment, the optical elements 116a-116c are lenses and this arrangement of the lenses is known as a Hybrid-Scheimpflug arrangement. It was recognized that this arrangement of the components of the system 100′ advantageously results in the housing 112 being more compact than without this arrangement. In an example embodiment, this arrangement of the components of the system is responsible for the cameras 115a-115b being spaced at the reduced distance 130 and thus being capable of receiving the light with the reduced angular spread 134 from the optical elements 116a-116c (FIG. 2B).

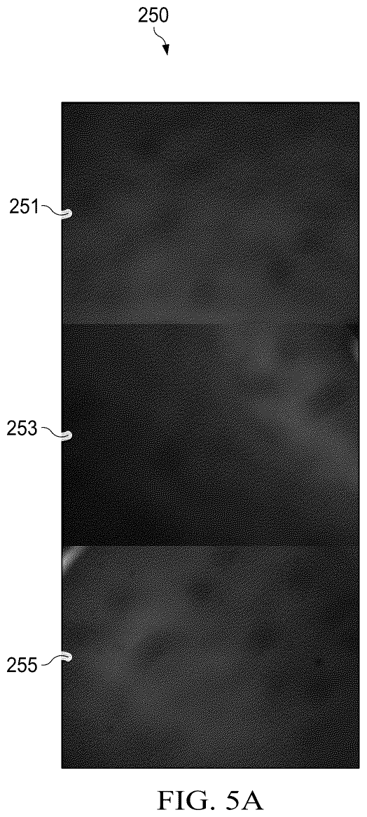

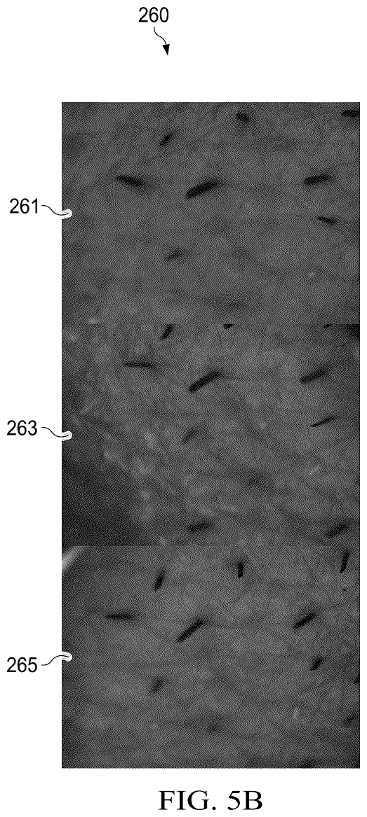

As image data is captured by the cameras 115a-115c, the controller 110 determines whether the image data is in focus on the surface or features 124 projecting from the surface 114. This determination is made in order to decide whether to capture image data over a plurality of frames. This advantageously ensures that image data over the plurality of frames is not captured when the surface 114 or features 124 projecting from the surface 114 is out of focus. FIG. 4A is an example according to various embodiments illustrating an out of focus region 210 in an image captured from the cameras 115a-115c of the system 100 of FIG. 2A. FIG. 4B is an example according to various embodiments illustrating an in-focus region 212 in an image captured from the cameras 115a-115c of the system of FIG. 2A. As appreciated by one skilled in the art, the image data captured by the cameras includes a plurality of pixels where each pixel a respective intensity value. In an embodiment, the out of focus region 210 is determined based on a transition in the pixel intensity being smaller than a threshold value between adjacent pixels 202 within and outside the region 210. Similarly, the in focus region 212 is determined based on a transition in the pixel intensity being larger than the threshold value between adjacent pixels 202 within and outside the region 210.

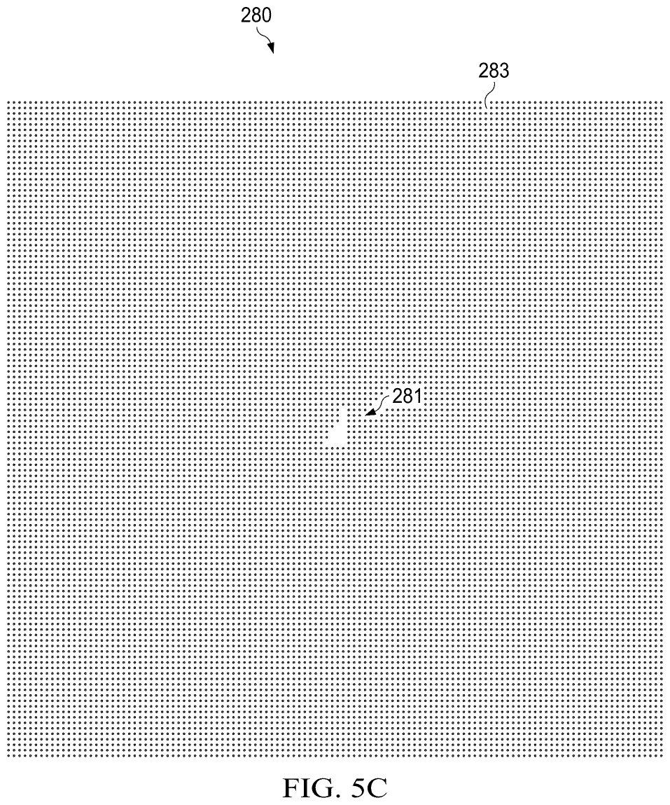

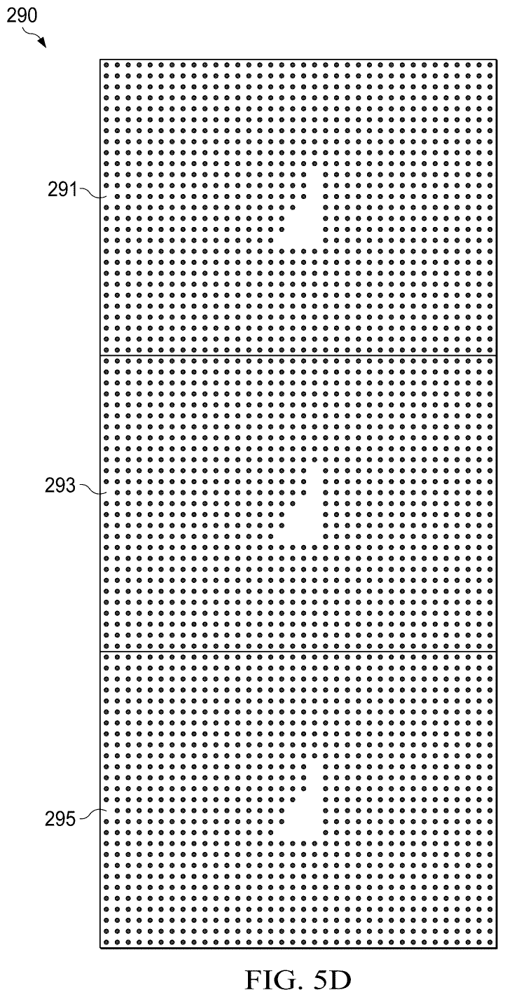

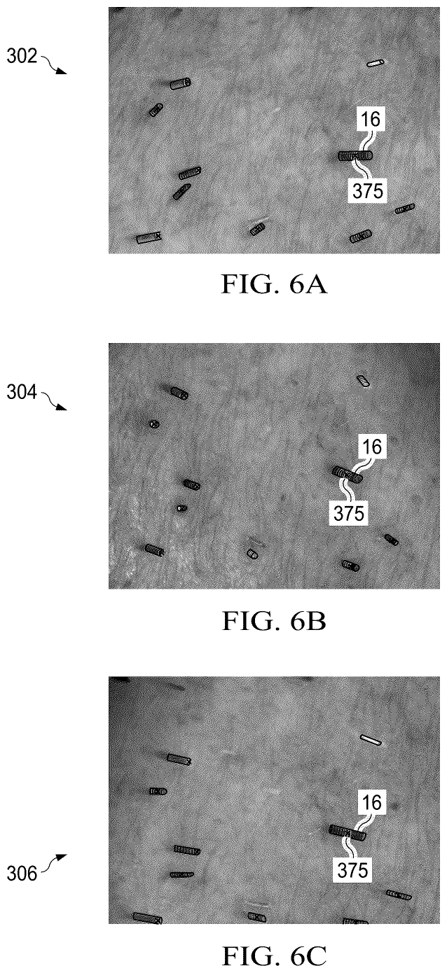

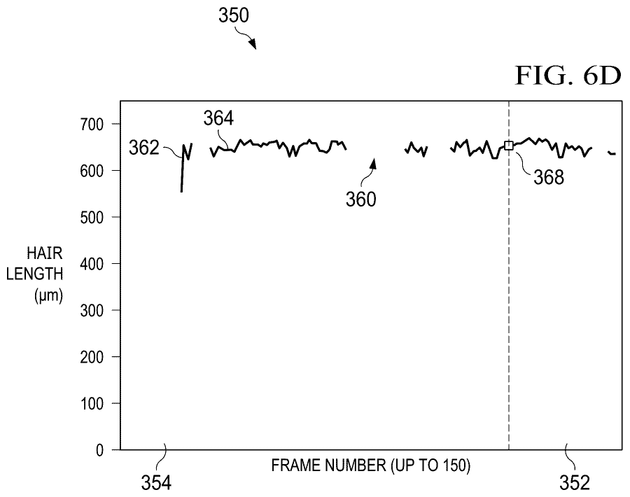

The processing of the image data by the controller will now be discussed. The image data captured by the cameras and sent to the controller is processed by the controller. In an embodiment, the controller 110 combines the image data from each of the plurality of cameras 115a-115c for each frame into a 3D bitmap image. FIG. 5A is an example according to various embodiments illustrating a 3D bitmap image 250 of skin features based on the image data collected by the system 100 of FIG. 2A. In an embodiment, as shown in FIG. 5A the 3D bitmap image 250 includes a plurality of regions 251, 253, 255 which are each based on the image data provided by a respective cameras 115a, 115b, 115c for a respective frame of the plurality of frames.

FIG. 5B is an example according to various embodiments illustrating a 3D bitmap image 260 of skin features based on the image data collected by the system 100 of FIG. 2A. In an embodiment, the 3D bitmap image 260 also includes a plurality of regions 261, 263, 265 which are each based on the image data provided by a respective camera 115a, 115b, 115c at a respective frame of the plurality of frames. In one embodiment, the 3D bitmap images 250, 260 are based on image data captured by the cameras 115a-115c at different frames (e.g. different times). In an example embodiment, the 3D bitmap image 260 is more in focus on the skin surface 14 and surface features (e.g. hairs 16) than the 3D bitmap image 250. In an example embodiment, the 3D bitmap image 260 is more in focus on the skin surface 14 and surface features (e.g. hairs 16) due to the cameras 115a-115b moving more into focus on the skin surface 14 and surface features (e.g. hairs 16) when the image data used to generate the 3D bitmap image 260 was captured.

The system including the cameras are calibrated before image data of the surface or features projecting from the surface is captured. This calibration is used to scale the image data captured by the cameras, such that the controller can determine a value of one or more dimensions from the captured image data. In order to calibrate the system, an object with a known geometry is positioned in front of the cameras 115a-115c. The object is illuminated with light 133 from the radiation source 117. Image data is captured of the object with the cameras 115a-115c. The cameras 115a-115c are then moved away from the object at one or more incremental distances (e.g. 10 μm) and the image data is recaptured at each incremental distance. Image data is recaptured at a certain number (e.g. 60) of incremental distances. In some embodiments, a glass plate is used and positioned between the calibration object and the cameras when the image data is captured. Based on this captured data, the controller determines a 3D model of the object with the known geometry. Since the dimensions of the object are known, the controller can correlate the scale of the 3D model with the known dimensions of the object. This correlation is 3D calibration data which is stored in a memory of the controller 110. When image data is then captured of the skin features 16 on the skin surface 14 and combined into a 3D model of the skin features 16, the controller 110 can determine a value of one or more dimensions of the 3D model, based on this stored 3D calibration data.

FIG. 5C is an image that illustrates an example of a front view of a calibration object 280 used to calibrate the system 100 of FIG. 2A, according to an embodiment. As shown in FIG. 5C, the calibration object 280 includes a plurality of spaced apart dots 283 where the spacing between adjacent dots is known (e.g. 100 μm). Additionally, the calibration object 280 includes a reference triangle 281 at a center of the object 280, which is used as a reference point to identify the various dots 283 of the object 280. In one embodiment, during the calibration step, the cameras 115a-115c are used to capture image data of the calibration object 280 at a certain number (e.g. 60) of various incremental spacings (e.g. 10 μm) between the cameras 115a-115c and the object 280. In an embodiment, the controller 110 then combines this image data (at each incremental spacing) into a 3D bitmap image 290, such as illustrated in FIG. 5D. In an embodiment, the controller 110 combines a plurality of 3D bitmap images based on the image data collected at each incremental spacing into a 3D model of the calibration object 280. As previously discussed, since the dimensions of the object 280 are known, the controller 110 then determines 3D calibration data which correlates the measured dimensions of the 3D model with the known dimensions of the object 280. This 3D calibration data is then stored in a memory of the controller 110.

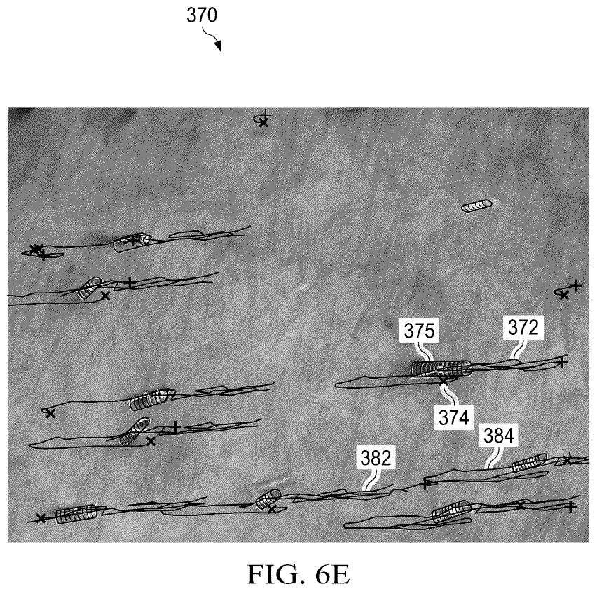

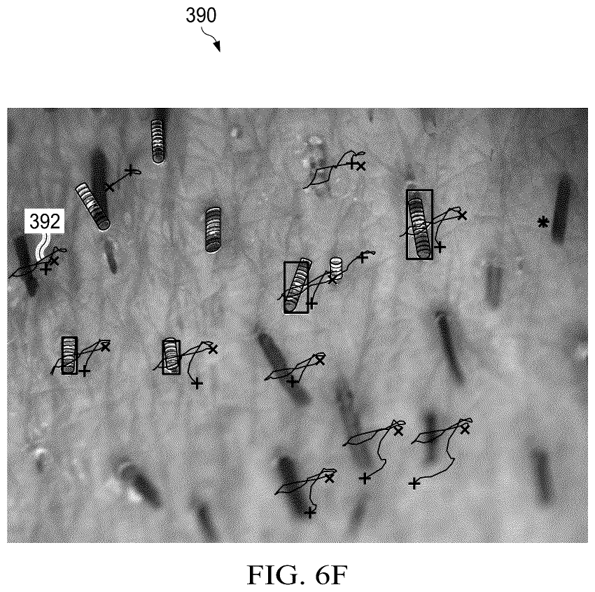

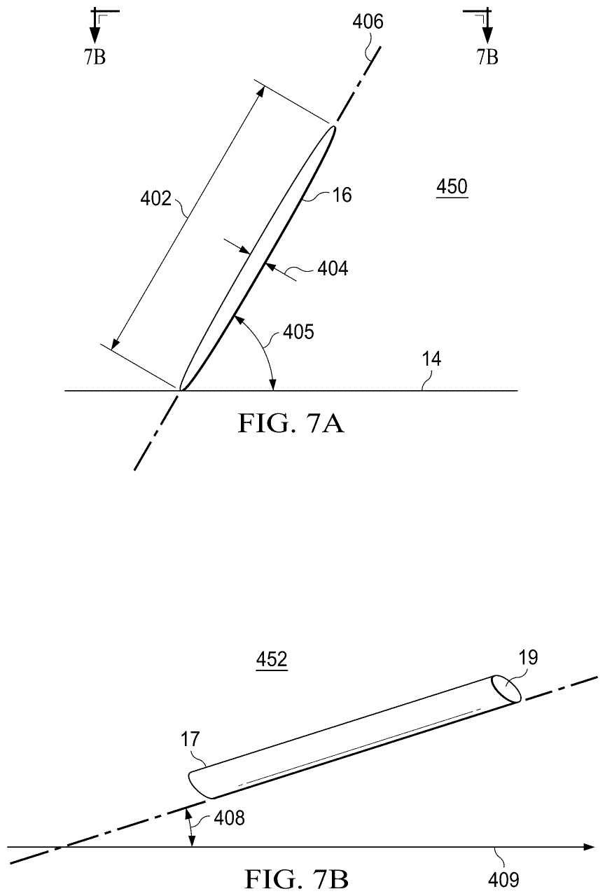

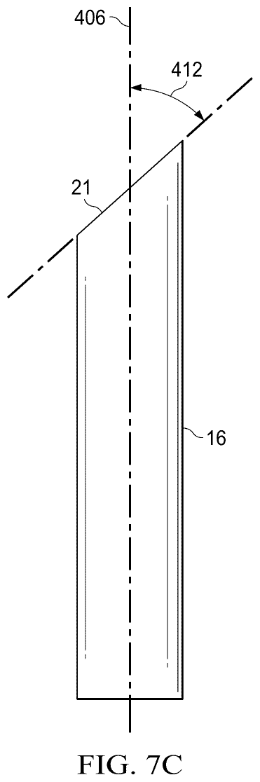

Images captured from each of the cameras is now discussed. The method disclosed herein is used to automatically identify one or more surface features (e.g. hairs) in each of the images. FIGS. 6A through 6C are images 302, 304, 306 that illustrate an example of image data of skin features (e.g. hairs 16) on the skin surface 14 collected by the cameras 115a-115c of the system 100 of FIG. 2A, according to an embodiment. In an embodiment, each of the images 302, 304, 306 are captured with a respective camera 115a, 115b, 115c. The images 302, 304, 306 are output on respective displays (e.g. displays 614) of the system 100. In one embodiment, the method disclosed herein outputs one or more location identifiers 375 on each image 302, 304, 306 which indicate a common location of a same surface feature (e.g. hair 16) in each image. In one embodiment, the location identifier 375 indicates an area and/or perimeter of the same surface feature (e.g. same hair 16) in each image 302, 304, 306. In another embodiment, the location identifier 375 is color coded such that the same identifier 375 for the same surface feature can be easily located in each image 302, 304, 306. Thus, in this example embodiment, a first surface feature (e.g. first hair 16) may have a location identifier 375 with a first color spectrum in each image 302, 304, 306 whereas a second surface feature (e.g. second hair 16) may have a location identifier 375 with a second color spectrum different from the first color spectrum in each image 302, 304, 306. It was recognized that the location identifier 375 conveniently assists the user of the method viewing the image 302, 304, 306 to easily identify the same surface feature in the different images.

The method disclosed herein is used to measure a parameter value (e.g. length, diameter, angle, etc.) of the same surface feature (e.g. hair 16) on the skin surface 14 over a plurality of frames. These measured parameter values of the same surface feature over the plurality of frames can be depicted in a graph. FIG. 6D is a graph 350 that illustrates an example of a measured parameter value of a hair 16 on the skin surface 14 over a plurality of frames, according to an embodiment. The horizontal axis 352 is the plurality of frames (unitless). The vertical axis 354 is the measured parameter value (in μm). The trace 364 includes a plurality of measured parameter values of each of the plurality of frames. A gap 360 in the trace 364 is present, for those frames where no measured parameter value was obtained. In some embodiments, no measured parameter value is due to the hair 16 being out of focus in the image data for that particular frame.

In other embodiments, no measured parameter value is due to the hair 16 exiting the field of view of the cameras 115a-115c for that frame and thus being absent in the image data. The 3D model of the skin surface 14 and features (e.g. hairs 16) on or projecting from the surface 14 that is determined by the method herein is used to determine when any such hair 16 that exits the field of view of the cameras 115 returns to the field of view. This is achieved based on the 3D model identifying the location of other features (e.g. moles, skin flakes, clothing fibers, skin texture lines, etc.) that surround the hair 16 and thus by using the relative location or position between the hairs 16 and the other features, the controller determines that the hair has returned to the field of view based on the location or position of surrounding features that have also returned to the field of view. In still other embodiments, no measured parameter value being measured is due to the hair 16 not being in focus in a threshold number (e.g. two) of the images 302, 304, 306 from the cameras 115a-115c.

In another embodiment, the graph 350 depicts a median parameter value 368 which is computed based on a median value of the measured parameter values in the trace 364 over the plurality of frames. In yet another embodiment, the graph 350 depicts outliers 362 which are not used in computing the median parameter value since they are not within a threshold percentage (e.g. 10%, 20%, etc) of the median parameter value 368.

As previously discussed with respect to FIG. 6A, location identifiers can be output on a display to indicate the location of a same surface feature in multiple images. In addition to this location identifier, other identifiers can also be output on the multiple images to indicate the location of the same surface feature over the plurality of frames. FIG. 6E is an image that illustrates an example of image data of the skin surface 14 with one or more location identifiers 374, 375 and tracking splices 372, 382, 384 for hairs, according to an embodiment. The location identifier 375 is similar to the location identifier 375 of FIG. 6A, which indicates a location of the hair 16 in each image 302, 304, 306. As with the location identifier 375 of FIG. 6A, the location identifier 375 of FIG. 6E indicates an area and/or boundary of the same surface feature in each image 302, 304, 306. In addition to the location identifier 375, a hair center location identifier 374 is output in the image 370 which indicates a center location of the same hair 16 in each of the images. In an example embodiment, the hair center location identifier 374 uses different symbols to indicate the center location of the hair 16 at different frames. In one example embodiment, the hair center location identifier 374 is a symbol (e.g. “small square”) to indicate the location of the center of the hair 16 in the current frame displayed in the image 370. In another example embodiment, the hair center location identifier is a different symbol (e.g., “+” sign) to indicate the location of the center of the hair 16 in a first frame of the plurality of frames where the hair 16 is sufficiently in focus to begin measurement. In still another example embodiment, the hair center location identifier is a different symbol (e.g. “x” sign) to indicate the location of the center of the hair 16 in a last frame of the plurality of frames where the hair 16 is sufficiently in focus to be measured. In yet other embodiments, the hair center location identifiers can have a designated color (e.g. white) so that a user of the method can easily identify the center location of the same hair 16 in each image.

In addition to indicating the center of the location of the surface feature in each image, the method is further capable to indicating a tracking splice that indicates a history of the center of the location of the surface type over the plurality of frames. In an embodiment, the image 370 of FIG. 6E outputs tracking splices 372, 382, 384 that indicate the history or trajectory of the center location of different surface features (e.g. hairs 16) over the plurality of frames. In one embodiment, the tracking splices 372, 382, 384 have different characteristics (e.g. different colors) to indicate that they represent the location history or trajectory of different hairs 16 over the plurality of frames. It was realized that this advantageously communicates to a user of the method that the tracking splices are for different hairs 16 on the skin surface 14. In some embodiments, where a tracking splice has one or more breaks (e.g. due to the hair going out of focus or leaving the image field of view) a user can use an input device 612 (e.g. mouse, touchscreen, etc.) to select the broken track splices and merge them to confirm that they belong to the same hair 16. By having the tracking splices with different colors, the user can easily distinguish which broken track splices belong to the same hair 16. In other embodiments, the method includes an option where the user can view a moving picture on the display of the images 302, 304, 306 from the cameras over the plurality of frames. By viewing this moving picture, the user can view the movement of the center location (e.g. identifier 374) over the frames to confirm that the center location moves along the path of the tracking splice 372, 382, 384. This visual confirmation is used to validate that each tracking splice belongs to the same surface feature (e.g. hair 16).

In still other embodiments, the tracking splices are compared to determine whether they show the same pattern. It was recognized that such a determination is relevant, as it shows how the cameras 115a-115c moved frame to frame, and consistency in these traces 372, 382, 384 is an indicator that the hair tracking was working for each individual hair 16. When tracking fails for one of the hairs, the splice for that particular hair shows a very different trace from the other hair traces. In some embodiments, the user can then consider this as a potential reason to exclude the tracking splice for a particular hair. However, in other embodiments, this distinction between the tracking splice for one hair relative to the other tracking splices of the other hairs may indicate that the hairs were in focus in a different set of frames. Consequently, in these embodiments, a differently shaped tracking splice for a particular hair is not always used as a basis to exclude the tracking splice.

In addition to indicating the measured location of one or more surface features, the method is further capable of outputting indicators of an error in measuring the location of a surface feature. FIG. 6F is an image 390 that illustrates an example of image data of the skin surface with a trace 392 indicating an error measurement of a hair 16, according to an embodiment. In an embodiment, the error trace 392 has a designated color (e.g. red) to indicate to the user that it represents a likely erroneous location measurement of a surface feature (e.g. hair). In some embodiments, the error trace 392 is output when a measured center location (e.g. indicated by the center identifier 374) does not overlap with the location identifier 375 of the same hair. As shown in some portions of the image 390 in FIG. 6F, some of the error traces 392 are provided where the center identifier 374 (e.g. symbol “X”) does not overlap with a location identifier 375 (e.g. color spectrum over the boundary or perimeter of the hair 16).

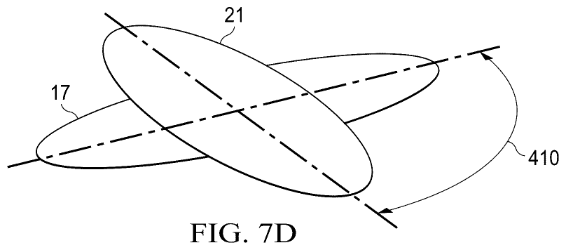

The method is used to measure one or more parameter values of surface features 124 (e.g. hairs 16) on the surface 114 (e.g. skin surface 14). These parameters will now be discussed. FIGS. 7A through 7D are images that illustrate an example of different parameters of hairs 16 on the skin surface 14, according to an embodiment. In an embodiment, FIG. 7A indicates a hair 16 on the skin surface 14. In this embodiment, the parameter includes a length 402 and a diameter 404 of the hair 16. In another embodiment, the parameter includes an elevation angle 405 of the hair 16 relative to the skin surface 14. In an example embodiment, the elevation angle 405 is measured in a first plane 450 that is normal to the skin surface 14. In an example embodiment, the value of the elevation angle 405 is between 0 and 90 degrees.

In another embodiment, as shown in FIG. 7B which is taken along the line 7B-7B of FIG. 7A, the parameter includes a projection angle 408 of a base 17 of the hair 16 in a second plane 452 that is normal to the first plane 450. In this embodiment, FIG. 7B is a top down view of the hair 16 depicted in FIG. 7A. In one embodiment, the projection angle 408 is measured relative to a same reference direction 409 for each hair 16. In an example embodiment, the value of the projection angle 408 is between 0 and 360 degrees.

In another embodiment, as shown in FIG. 7C, the parameter includes a tip cut angle 412 which is an angle between a longitudinal axis 406 of the hair 16 and a tip surface 21 at a tip of the hair 16. In this embodiment, FIG. 7C is a side view of the hair 16 depicted in FIG. 7A. In one embodiment, the tip cut angle 412 is measured relative to the tip surface 21 and is between 0 and 90 degrees.

In another embodiment, as shown in FIG. 7D, the parameter includes a swing angle 410 which is an angle between the tip surface 21 and the base 17 of the hair 16. More specifically, as shown in FIG. 7D, the swing angle 410 is an angle between a longitudinal axis of the tip surface 21 (e.g. long axis along the elliptical shaped tip) and a longitudinal axis of the hair base 17 (e.g. long axis along the elliptical shaped base). In one embodiment, the swing angle 410 is between 0 and 360 degrees.

### Method for Gathering Image Data of Surface Features

A method will now be discussed to gather image data of a surface and features projecting from the surface. In an embodiment, the method is performed with the system 100 previously discussed herein. FIG. 8A is a flow diagram that illustrates an example method 500 to capture image data of a surface 114 with features 124 with the system 100 of FIG. 2A, according to an embodiment. Although steps are depicted in FIG. 8A, and in subsequent flowchart of FIG. 8B, as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

The method 500 begins at step 501 where the 3D calibration data of the system 100 is determined. As previously discussed, the 3D calibration data is determined by positioning a calibration object (e.g. calibration object 280 of FIG. 5C) in front of the cameras 115a-115c and capturing image data a plurality of incremental spacings (e.g. 60 spacings that are incrementally spaced 10 μm apart) between the object 280 and the cameras 115a-115c. In an example embodiment, in step 501 the image data of the calibration object 280 is captured at an initial spacing of 300 μm and subsequently increased spacings of 10 μm until a desired number (e.g. 60) images are captured. Based on the image data gathered at each spacing between the calibration object 280 and the cameras 115a-115c, a respective 3D bitmap image 290 is generated for each spacing. The controller 110 then combines the plurality of 3D bitmap images 290 of the calibration object 280 into a 3D model of the calibration object 280. The controller 110 then determines the 3D calibration data that correlates the dimensions of the 3D model of the calibration object 280 with known dimensions of the calibration object 280. The controller 1100 then stores this 3D calibration data in a memory of the controller 110. This 3D calibration data is then used in later steps of the method 550 for measuring parameter values of surface features, based on a generated 3D model of the surface.

In step 503, image data is then captured of the surface 114 with features 124 with the system 100. In an embodiment, in step 503 the surface 114 is the skin surface 14 and the features are hairs 16. In some embodiments, step 503 is repeated for multiple regions of the skin surface 14 (e.g. multiple regions of the head including cheek, chin, jaw, neck, scalp, or leg, axilla, pubis, etc.). In one embodiment, in step 503 the controller 110 transmits a signal to each of the radiation source 117 and the cameras 115a-115c to cause the radiation source to transmit light and the cameras to capture image data of the area 122 of the surface 114 with features 124. In another embodiment, in step 503 a user moves the housing 112 of the system 100 to within a close proximity (e.g. within 1 millimeter, such within a range between about 400 μm and 800 μm) of the surface 114 with features 124. Additionally, in step 503 image data is transmitted from the cameras 115a-115c to the controller 110.

In step 505, a determination is made whether the image data captured in step 503 is in focus or at least sufficiently in focus. In an embodiment, in step 505 the controller 110 processes the image data received from the cameras 115a-115c in step 503 into a 3D bitmap image 250 (FIG. 5A). In this embodiment, in step 505 the controller 110 determines whether the 3D bitmap image 250 is in focus or at least sufficiently in focus. For purposes of this description, “sufficiently in focus” means that surface features in the 3D bitmap image are discernible although they may not be in tight enough focus to permit measurement of parameter values (e.g. length, diameter, etc.) of the surface features. In an example embodiment, surface features (e.g. hairs 16) in the regions 251, 253, 255 of the 3D bitmap image 250 are not in close enough focus to measure parameter values (e.g. length, diameter, etc.) yet they are discernable from the skin surface. In this embodiment, in step 505 upon determining that the surface features are sufficiently in focus, the method 500 beings to save captured image data in frames on the assumption that focus of the surface features will improve sufficiently (e.g. as shown in regions 261, 263, 265 in the 3D bitmap image 260 based on image data captured at a later frame) so that parameter values of the surface features can be measured.

In one example embodiment, in step 505 the controller 110 determines that the 3D bitmap image 250 is in sufficient focus based on reviewing the regions 251, 253, 255 of the 3D bitmap image 250 corresponding to the respective cameras 115a, 115b, 115c. If the controller 110 determines that a minimum number (e.g. two) of the regions 251, 253, 255 of the 3D bitmap image 250 are sufficiently in focus, then the controller 110 determines that the image data captured in step 503 is sufficiently in focus. In some embodiments, in step 505 the controller 110 determines whether the regions 251, 253, 255 are sufficiently in focus or coming into focus (e.g. based on the transition between pixel intensity between adjacent pixels 202). Thus, in step 505 for the controller 110 to determine that the image data is sufficiently in focus, the different regions 251, 253, 255 need not be in tight focus such that parameter values (e.g. length, diameter, etc.) of each surface feature (e.g. hair 16) can be measured. It was recognized that step 505 is advantageous as it indicates whether the cameras 115a-115c are approaching an ideal focal distance from the surface 114 including features 124 and thus can be used to decide whether to commence to capture image data of the surface 114 including features 124 over a plurality of frames. If the determination in step 505 is affirmative, then the method 500 moves to step 509.

If the determination in step 505 is negative, then the captured image data in the frame is discarded and the method 500 moves back to step 503.

After the controller 110 determines in step 505 that the captured image data is sufficiently in focus, the method 500 proceeds to step 509.

In step 509, the controller generates a 3D bitmap image based on the image data captured in step 503. In an embodiment, in step 509 the controller 110 generates the 3D bitmap image 250 based on the image data (e.g. images 302, 304, 306 of FIG. 6A) received from the cameras 115a-115c.

In step 511, the 3D bitmap image generated in step 509 is stored. In an embodiment, in step 511 the 3D bitmap image is stored in a memory of the controller 110. In another embodiment, in step 511 the 3D calibration data determined in step 501 is also stored in the memory of the controller 110. In some embodiments, in step 511 the 3D bitmap image is stored based on one or more of an identifier for the subject with the skin surface 14, an identifier of the date that the 3D bitmap image was generated and an identifier for a region of the skin surface 14 that was imaged (e.g. left cheek, center chin, etc.).

In step 513, the controller determines whether a time limit or frame limit has been reached. In an embodiment, in step 513 the controller 110 determines whether the generated 3D bitmap image in step 509 is for a last frame of the plurality of frames (e.g. 150 frames). This determination is based on determining whether more frames of the plurality of frames need to have steps 509 and 511 performed, if the image data of such frames is in sufficient focus. In an embodiment, the plurality of frames is based on a frame capture rate (e.g. 30 frames per second) of the cameras 115a-115c and a time period (e.g. 5 seconds) which the cameras 115a-115c capture the images. Thus, in some embodiments, the determination in step 513 is based on the controller 110 determining whether a certain time period (e.g. 5 seconds) has elapsed such that the plurality of frames (e.g. 150) are captured with the cameras 115a-115c having the frame capture rate (e.g. 30 frames per second). In this embodiment, the determination in step 513 is in the affirmative until the certain time period (e.g. 5 seconds) has elapsed.

If the determination in step 513 is in the negative, the method 500 moves to step 515 where image data of the surface features 124 for the next frame is captured with the camera system 100. If the determination in step 513 is in the affirmative, then the method 500 ends since there are no more frames over which image data is to be captured and 3D bitmaps to be generated.

After determining in step 513 that the time or frame limit has not been reached and the image data is captured in step 515, in step 517 a determination is made by the controller similar to step 505 as to whether the image data captured in step 515 is sufficiently in focus. If the determination in step 517 is in the affirmative, the method 500 moves back to step 509 so that a 3D bitmap image is generated based on this image data. The generated 3D bitmap image is then stored in step 511 before the determination in 513 is repeated.

If the determination in step 517 is in the negative, then the captured image data in step 515 is not sufficiently in focus. As nothing in the image is sufficiently in focus, data capture stops and the process ends. In an embodiment, the method 500 restarts from the beginning after a short delay (e.g. a few seconds) while the controller 110 completes saving of all the image frames.

### Method for Determining Parameter Values of Surface Features

A method will now be discussed to measure a value of one or more parameters of a surface feature, based on image data gathered from a surface with the surface feature. In an embodiment, the method measures values of one or more parameters of a surface feature based on the image data obtained from the method 500 (e.g. 3D calibration data and the 3D bitmap images of the surface over the plurality of frames). In some embodiments, the surface 114 is a skin surface 14 and the surface feature 124 is a skin feature (e.g. hair 16, mole, etc.).

FIG. 8B is a flow diagram that illustrates an example method 550 to measure a value of one or more parameters of surface features based on the image data captured with the system 100 of FIG. 2A, according to an embodiment. The method 550 begins at step 551 where the 3D calibration data and the 3D bitmap images of the surface 114 including the surface features 124 over a plurality of frames are obtained. In an embodiment, the 3D calibration data and the 3D bitmap images of the surface 114 including features 124 over the plurality of frames are obtained from the method 500. In other embodiments, the 3D calibration data and the 3D bitmap images are obtained from another source without performing the steps of the method 500.

In step 553, a 3D model of the surface features 124 on the surface 114 is generated based on the 3D calibration data and the 3D bitmap image of the features 124 on the surface 114 for a first frame of the plurality of frames. The 3D model combined with the 3D calibration data indicates the position of surface features 124 in each region of the surface 114 and thus based on the 3D model and 3D calibration data the controller 110 can determine the relative position of different features 124 in different regions of the surface 114. In one embodiment, in step 553 the 3D model of the surface features 124 is generated based on the 3D calibration data and the 3D bitmap image 260 (FIG. 5B) that was obtained based on the image data captured at the first frame. In an embodiment, the 3D model is generated with the 3D calibration data and 3D bitmap image using any conventional method known in the art [1].

In one embodiment, in step 553 the 3D model is generated using the 3D bitmap image 260 and 3D calibration data by excluding one or more regions 261 from the 3D bitmap image 260 which indicates a parameter value of the surface feature that deviates by a threshold amount (e.g. 20%) from the parameter values indicated by the other regions 263, 265.

In an embodiment, the 3D model generated in step 553 creates and tracks from frame to frame where in 3D space the surface features are in relation to each other. While in some embodiments, the 3D model generated in step 553 uses in-focus cylindrical features (e.g. hairs 16) of the skin surface 14, in other embodiments the 3D model generated in step 553 also uses in-focus non-cylindrical features on the skin surface 14 (e.g. flakes of dry skin or contamination such as clothing fibers) for tracking position of the surface features. In these embodiments, the 3D model generated in step 553 can track the position or orientation in 3D space of each of these surface features, based on a relative position or orientation between these surface features in 3D space.

In an example embodiment, as part of the modelling in step 553, the controller attempts to determine the orientation of the cylindrical surface features, such as the hairs 16, which is based on identifying the ‘top’ and ‘bottom’ ends of the cylindrical surface features. In this example embodiment, when generating the 3D model the controller identifies the ‘top’ end of the cylindrical surface features (e.g. hairs 16), by recognizing that the ‘top’ end will have a cut angle and a value for the swing angle 410 (FIG. 7D). Additionally, in this example embodiment, when generating the 3D model the controller identifies the ‘bottom’ end of the cylindrical features (e.g. hairs 16) by recognizing that the ‘bottom’ end should stop when the intensity (e.g. pixel intensity in the captured image data and generated 3D bitmap image) of the cylindrical feature markedly changes (e.g., when it enters the skin). As previously discussed, the radiation source 117 was selected such that the skin boundary is usually marked by a sudden change in the intensity of reflected light from the surface feature. In step 553, the controller identifies this change, based on the generated 3D bitmap and captured image data and thus determines the position of the ‘bottom’ end of the hair 16. This advantageously results in the controller not measuring anything below the level of the skin surface 14, which improves the accuracy of the 3D model. In some embodiments, in generating the 3D model in step 553 although the controller finds, tracks and measures cylindrical features (e.g. hairs), non-cylindrical features (e.g. skin flakes) are also modeled so they can be excluded from measurement, and not mistakenly identified as a hair, especially when the color of the non-cylindrical features (e.g. white) is the same color as some of the cylindrical features (e.g. hairs).

In step 555, for those surface features which are in focus in the model generated in step 553, a value of one or more parameters of the surface features are measured. Thus, in an embodiment, in step 555 the 3D model generated in step 553 is first assessed to see whether one or more surface features 124 (e.g. hairs 16) are in focus. This determination in step 555 of whether the hairs 16 are in focus in the 3D model is distinct from step 505 of the method 500 which assessed whether the image data is sufficiently in focus (or coming into focus). In one embodiment, the determination in step 555 of whether the hairs 16 in the 3D model are in focus has a higher threshold (e.g. has a higher threshold value for the difference in pixel intensity between adjacent pixels 202 within and outside a hair 16 in the 3D model). As shown in FIG. 5B, in an embodiment, the 3D bitmap image 260 showing hairs 16 of the skin surface 14 in the different regions 261, 263, 265 is in focus for purposes of step 555. However, as shown in FIG. 5A in an embodiment, the 3D bitmap image 250 with the different regions 251, 253, 255 is not in focus for purposes of step 555, since the hairs 16 are not discernable. Consequently, the in-focus determination in step 555 is to assess whether the hairs 16 in the 3D model are sufficiently clear and distinct so that parameter values (e.g., length, diameter, etc.) of the hairs 16 can be measured within the calibrated zone. It was recognized that this in-focus determination in step 555 is performed to avoid measuring parameter values of hairs which are not in focus. Poorly focused features are outside the calibrated zone and thus cannot be accurately measured. If one or more surface features 124 (e.g. hairs 16) are in focus, then the method 550 proceeds to the next part of step 555 discussed below. If one or more surface features 124 (e.g. hairs 16) are not in focus, then the method 550 proceeds to step 557 and does not perform the next part of step 555 discussed below.

In step 555, after determining that one or more surface features (e.g. hairs 16) are in focus in the generated 3D model (and therefore within the calibrated zone), values of one or more parameters of the hairs 16 are measured. In an embodiment, the parameters include any of the parameters described in FIGS. 7A though 7D. The 3D model generated in step 553 indicates the position and orientation of surface features 124 in each region of the surface 114 and thus can be used to determine the relative position of different surface features 124 in different regions of the skin surface 14, including the relative position of different portions of the hairs 16 on the skin surface 14. Hence, in step 555 the controller 110 uses the 3D model to measure the parameter values of the hairs 16 based on determining the relative position of different portions of the hairs 16. FIGS. 7A through 7D depict the different portions of the hairs 16 and skin surface 14 that are used to measure the various parameter values. If the surface features are not in focus or not otherwise assessable to measure the parameter value, the method 550 bypasses step 555 to step 557 and thus the parameter value is not determined in step 555.

In step 557, the 3D bitmap image of a next frame is then evaluated to determine whether one or more surface features 124 (e.g. hairs 16) are in focus. In an embodiment, step 557 is similar to the first part of step 555. If step 557 determines that one or more surface features are in focus in the next 3D bitmap image, the method 550 proceeds to step 559. If step 557 determines that one or more surface features are not in focus in the next 3D bitmap image, the method 550 moves to step 563.

In step 559, the 3D model generated in step 553 is updated based on the next 3D bitmap image evaluated in step 557 and the 3D calibration data. In an embodiment, step 559 updates the 3D model from step 553 based on another 3D bitmap image of the surface 114 taken at a different frame after the first frame. In an embodiment, the 3D model is updated in step 559 using similar techniques as discussed with respect to step 553 when the 3D model is generated. It was recognized that this updating of the 3D model enhances the 3D model by supplementing the 3D model with additional surface features and additional surfaces of such surface features that may not have been in the 3D model generated in step 553.

In one embodiment, in step 559 the 3D model is updated using the 3D bitmap image 260 and 3D calibration data by excluding one or more regions 261 from one of the cameras 115a-115c which indicates a parameter value of the surface feature that deviates by a threshold amount (e.g. 20%) from the parameter values indicated by the other regions 263, 265.

In step 561, values of one or more parameters of the surface features (e.g. hairs 16) that are in focus in the 3D model are measured. In one embodiment, this higher threshold of focus ensures that any features measured are within a certain range (e.g. from about 400 μm to about 800 μm) of the surface 114 with features 124. For purposes of this disclosure, this is known as the calibrate zone. In an embodiment, step 561 is performed in a similar manner as the second part of step 555 with the exception that step 561 is performed using the updated 3D model from step 559. If the surface features are not in focus or not otherwise assessable to measure the parameter value, the method 550 bypasses step 561 to step 563 and thus the parameter value is not determined in step 561.

In step 563, a determination is made whether the 3D bitmap images from each of the plurality of frames have been considered. In an embodiment, in step 563 a determination is made based on a counter that determines whether step 557 has been performed a certain number of times (e.g. the number of the plurality of frames).

In step 565, a characteristic of the parameter values of the surface features over the plurality of frames (measured in steps 555 and 561) is calculated. In one embodiment, the characteristic is a median. In other embodiments, any other metric of the parameter values can be calculated (e.g. average, minimum, maximum, standard deviation, etc.). In an embodiment, in step 565 the graph 350 is generated which indicates the calculated median parameter value 368. In another embodiment, in step 565 the graph 350 depicts the number of samples (e.g. 101) of the plurality of frames (e.g. 150) for which the parameter values were measured in steps 555 or 561. In this example embodiment, some of the frames (e.g. 49) did not have a measured parameter value since the surface features were not in focus in the determinations in step 555 or 557 and thus the step of measuring the parameter values was not performed in steps 555 or 561. Hence the gap 360 is depicted in the graph 350. The graph 350 is merely one example embodiment of measured parameter values based on the method 550 for one example of 3D calibration data and 3D bitmap images generated over a plurality of frames.

In step 567, the calculated values from step 565 are stored in a memory. In one embodiment, the calculated values in step 565 are calculated median values of the parameter values measured in steps 555 and 561. In another embodiment, in step 567 the calculated values are stored in a memory of the controller 110. In an example embodiment, the 3D bitmap images obtained in step 551 are from a respective region of the skin surface 14 (e.g. cheek, jaw, chin, neck, etc.) and thus in step 567 the calculated values are stored along with an identifier of the region of the skin surface 14. In still another example embodiment, in step 567 the calculated values are stored with an identifier of a subject with skin surface 14 and an identifier of a date that the 3D bitmap images were generated or the method 550 was performed.

### Hardware Overview

FIG. 9 is a block diagram that illustrates a computer system 600 upon which an embodiment of the disclosure may be implemented. Computer system 600 includes a communication mechanism such as a bus 610 for passing information between other internal and external components of the computer system 600. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of one or more methods described herein.

A sequence of binary digits constitutes digital data that is used to represent a number or code for a character. A bus 610 includes many parallel conductors of information so that information is transferred quickly among devices coupled to the bus 610. One or more processors 602 for processing information are coupled with the bus 610. A processor 602 performs a set of operations on information. The set of operations include bringing information in from the bus 610 and placing information on the bus 610. The set of operations also typically include comparing two or more units of information, shifting positions of units of information, and combining two or more units of information, such as by addition or multiplication. A sequence of operations to be executed by the processor 602 constitutes computer instructions.

Computer system 600 also includes a memory 604 coupled to bus 610. The memory 604, such as a random access memory (RAM) or other dynamic storage device, stores information including computer instructions. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of computer instructions. The computer system 600 also includes a read only memory (ROM) 606 or other static storage device coupled to the bus 610 for storing static information, including instructions, that is not changed by the computer system 600. Also coupled to bus 610 is a non-volatile (persistent) storage device 608, such as a magnetic disk or optical disk, for storing information, including instructions, that persists even when the computer system 600 is turned off or otherwise loses power.

Information, including instructions, is provided to the bus 610 for use by the processor from an external input device 612, such as a keyboard containing alphanumeric keys operated by a human user, or a sensor. A sensor detects conditions in its vicinity and transforms those detections into signals compatible with the signals used to represent information in computer system 600. Other external devices coupled to bus 610, used primarily for interacting with humans, include a display device 614, such as a cathode ray tube (CRT) or a liquid crystal display (LCD), for presenting images, and a pointing device 616, such as a mouse or a trackball or cursor direction keys, for controlling a position of a small cursor image presented on the display 614 and issuing commands associated with graphical elements presented on the display 614.

In the illustrated embodiment, special purpose hardware, such as an application specific integrated circuit (IC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 670 sends and receives electrical, acoustic or electromagnetic signals, including infrared and optical signals, that carry information streams, such as digital data.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 602, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 602, except for carrier waves and other signals.

Logic encoded in one or more tangible media includes one or both of processor instructions on a computer-readable storage media and special purpose hardware, such as ASIC *620.

Network link 678 typically provides information communication through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690. A computer called a server 692 connected to the Internet provides a service in response to information received over the Internet. For example, server 692 provides information representing video data for presentation at display 614.

The disclosure is related to the use of computer system 600 for implementing the techniques described herein. According to one embodiment of the disclosure, those techniques are performed by computer system 600 in response to processor 602 executing one or more sequences of one or more instructions contained in memory 604. Such instructions, also called software and program code, may be read into memory 604 from another computer-readable medium such as storage device 608. Execution of the sequences of instructions contained in memory 604 causes processor 602 to perform the method steps described herein. In alternative embodiments, hardware, such as application specific integrated circuit 620, may be used in place of or in combination with software to implement the disclosure. Thus, embodiments of the disclosure are not limited to any specific combination of hardware and software.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server 692 transmits program code for a particular application, requested by a message sent from computer 600, through Internet 690, ISP equipment 684, local network 680 and communications interface 670. The received code may be executed by processor 602 as it is received, or may be stored in storage device 608 or other non-volatile storage for later execution, or both. In this manner, computer system 600 may obtain application program code in the form of a signal on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red a carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 10 illustrates a chip set 700 upon which an embodiment of the disclosure may be implemented. Chip set 700 is programmed to perform one or more steps of a method described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of a method described herein.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 705 also stores the data associated with or generated by the execution of one or more steps of the methods described herein.

### FURTHER DEFINITIONS AND CROSS-REFERENCES

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any disclosure disclosed or claimed herein or that it alone, or in any combination with any other reference or references, teaches, suggests or discloses any such disclosure. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A system comprising:
a plurality of cameras;
a plurality of optical elements configured to receive light from an area of a surface having one or more features and further configured to direct the light to the plurality of cameras;
at least one processor communicatively coupled with the plurality of cameras; and
at least one memory including one or more sequences of instructions,
the at least one memory and the one or more sequences of instructions configured to, with the at least one processor, cause the system to perform at least the following,
determine 3D calibration data of the plurality of cameras;
automatically receive image data of the area in focus from the plurality of cameras over a plurality of frames;
automatically determine a 3D bitmap image for each of the plurality of frames based on the image data for each of the plurality of frames; and
store the 3D calibration data and the 3D bitmap images over the plurality of frames in the memory.

2. The system of claim 1, wherein the surface is a skin surface.

3. The system of claim 1, wherein the plurality of cameras define a respective plurality of image planes; wherein the plurality of optical elements define a respective plurality of optical planes and wherein the plurality of optical elements are configured such that each optical plane intersects at least one of the image planes within a plane of focus.

4. The system of claim 3, wherein the plane of focus is aligned with the surface.

5. The system of claim 1, wherein the plurality of optical elements are configured to reduce a first angular spread of light received from the area of the surface to a second angular spread of light incident on the plurality of cameras, wherein the second angular spread is less than the first angular spread.

6. The system of claim 5, wherein the plurality of cameras are spaced apart by a first distance that is less than a second distance to space the plurality of cameras to receive light having the first angular spread without the plurality of optical elements.

7. The system of claim 1, wherein the system is a contactless system that is configured to receive the first image data and the second image data of the area of the surface without making contact with the surface.

8. The system of claim 7, further comprising a housing defining an opening, wherein the plurality of cameras are positioned within the housing; wherein the plurality of optical elements are positioned within the housing between the opening and the plurality of cameras and wherein the plurality of optical elements are configured to receive light through the opening from the area.

9. The system of claim 8, wherein the housing is configured to be positioned at a distance from the area of the surface that is greater than a minimum distance threshold and less than a maximum distance threshold.

10. The system of claim 9, wherein the minimum distance threshold is about 400 microns and the maximum distance threshold is about 800 microns.

11. The system of claim 1, further comprising a radiation source configured to output a radiation signal to illuminate the surface features, wherein an absorption of the radiation signal in the surface feature is different from the surface.

12. The system of claim 11, wherein the surface feature is a hair and the surface is a skin surface and wherein the radiation signal has a wavelength range such that the absorption of the radiation signal at the skin surface is greater than the absorption of the radiation signal at the hair.

13. The system of claim 12, wherein the wavelength of the radiation signal is within a range comprising at least one of a first range between about 500 nm and about 560 nm and a second range between about 1400 nm and about 1550 nm.

14. A method comprising:
determine, with a processor, 3D calibration data of a camera system including a plurality of cameras;
automatically receive, at the processor, first image data of an area of a surface having one or more features from the camera system over a plurality of frames;
automatically determine, with the processor, a 3D bitmap image for each of the plurality of frames based on the first image data for each of the plurality of frames; and
store, with the processor, the 3D calibration data and the 3D bitmap images over the plurality of frames.

15. The method of claim 14, further comprising:
receive, at the processor, second image data of the area of the surface from the camera system;
automatically determine, with the processor, whether the second image data is in focus with the surface;
and wherein the automatic receiving of the first image data over the plurality of frames is based on the second image data being in focus.

16. The method of claim 14, wherein the 3D calibration data is determined by capturing, with the plurality of cameras, image data of an object with a predetermined geometry at a plurality of separations between the plurality of cameras and the object.

17. A method comprising:
receive, at a processor, 3D calibration data and a plurality of 3D bitmap images of a surface over a respective plurality of frames;
automatically determine, with the processor, whether a surface feature in the 3D bitmap image for each frame is in focus;
automatically determine, with the processor, a 3D model of the surface features based on the 3D calibration data and one or more of the 3D bitmap images where the surface feature is in focus;
automatically determine, with the processor, a value of one or more parameters of the surface feature that is in focus based on the 3D model for the plurality of frames; and
automatically calculate, with the processor, a characteristic value of the one or more parameters of the surface feature over the plurality of frames; and
store, with the processor, the calculated characteristic value of the one or more parameters of the surface feature and an identifier that indicates the surface feature.

18. The method of claim 17:
wherein the automatically determining the 3D model of the surface is based on the 3D calibration data and the 3D bitmap image for a first frame of the plurality of frames;
wherein the automatically determining the value of the one or more parameters of the surface feature based on the 3D model is for the first frame of the plurality of frames; and
wherein the method further comprises:
automatically determine, with the processor, an updated 3D model of the surface based on the 3D calibration data and the 3D bitmap image for each of a next frame after the first frame where the surface feature is in focus; and
automatically determine, with the processor, the value of the one or more parameters of the surface feature based on the updated 3D model for each of the next frame after the first frame.

19. The method of claim 17, where the surface is a skin surface and the surface feature is a hair.

20. The method of claim 18, wherein the automatically determining the value of the parameter of the surface feature in the 3D model comprises automatically identifying a location of the surface feature in the 3D model for the first frame;
and wherein the automatically determining the value of the parameter of the surface feature in the updated 3D model comprises automatically identifying a location of the surface feature in the updated 3D model for each of the next frame after the first frame.

21. A method comprising:
determine, with a processor, 3D calibration data of a camera system including a plurality of cameras;
automatically receive, at the processor, first image data of an area of a skin surface having one or more hairs from the camera system over a plurality of frames;
automatically determine, with the processor, a 3D bitmap image for each of the plurality of frames based on the first image data for each of the plurality of frames; and
store, with the processor, the 3D calibration data and the 3D bitmap images over the plurality of frames.

22. A method comprising:
receive, at a processor, 3D calibration data and a plurality of 3D bitmap images of a skin surface over a respective plurality of frames;
automatically determine, with the processor, whether a hair in the 3D bitmap image for each frame is in focus;
automatically determine, with the processor, a 3D model of the hair based on the 3D calibration data and one or more of the 3D bitmap images where the hair is in focus;
automatically determine, with the processor, a value of one or more parameters of the hair that is in focus based on the 3D model for the plurality of frames; and
automatically calculate, with the processor, a characteristic value of the one or more parameters of the hair over the plurality of frames; and
store, with the processor, the calculated characteristic value of the one or more parameters of the hair and an identifier that indicates the hair.
